(19) United States
(12) Patent Application Publication
(10) Pub. No.: US 2025/0116088 A1
(43) Pub. Date: Apr. 10, 2025

(54) ARENA GROOMING MACHINES

(71) Applicant: Neil Merrill, Axtell, UT (US)

(72) Inventor: Neil Merrill, Axtell, UT (US)

(21) Appl. No.: 18/905,031

(22) Filed: Oct. 2, 2024

Related U.S. Application Data
(60) Provisional application No. 63/588,601, filed on Oct. 6, 2023.

(51) Int. Cl. E02F 3/627; E02F 9/28

(52) U.S. Cl. CPC E02F 3/627; E02F 9/2808

(57) ABSTRACT

The present disclosure includes improved arena grooming machines, as well as systems, methods and apparatus for arena grooming. In some illustrative embodiments, an improved grooming machine may include a number of digging shanks formed as a set on a framework that that can be adjusted to different depths and an additional set of maintaining shanks. The maintaining shanks may be designed thin to slit the deeper ground with reduced “digging” compared to the digging shanks and may be mounted on an independent bar deployable to a fixed consistent position. The maintaining shanks may be adjustable on the independent bar to allow for alignment with the wheels of the tractor to address compression occurring from repeated arena grooming. In some embodiments, an improved grooming machine may include an adjustable leveling bar assembly that can present the bar at different depths and different pitches and to be removed for replacement.

### CROSS-REFERENCE TO RELATED APPLICATION

This application claims priority to U.S. Provisional Patent Application No. 63/588,601, filed Oct. 6, 2023, which is incorporated herein by reference in its entirety, including but not limited to those portions that specifically appear hereinafter.

### TECHNICAL FIELD

The present disclosure relates to apparatus, systems and methods for arena ground maintenance, for use in connection with equine and rodeo events.

### BACKGROUND

Arena groundworking implements are typically tractor towed implements that are used to level and condition the ground forming the floor of an arena to provide a relatively consistent and level footing for animals, such as horses during events.

A typical preparation sequence for arena ground for an equine event uses an arena ground working machine of the known type (also called a “groomer) to dig up the ground at a relatively deeper depth (about 7″ to about 8″) and then make multiple passes at a shallower depth to remove air and compress the ground to a safe and desired consistency, prior to the commencement of the event. These known arena ground working machines typically include a number of digging shanks formed as a set on a framework that that can be adjusted to different depths followed by a fixed leveling bar, consisting of a flat bar or rod at a fixed position to flatten the ground surface during grooming.

As the event progresses, the horses' hooves will make ruts, divots and humps, producing rough and unsafe conditions. As the event progresses, periodic passes will be made with the groomer at the shallower depth to recondition the upper part of the arena ground for subsequent horses or competitors during the event. However, the tractor pulling groomer typically follows the same pathway for each pass, which over repeated times compacts the ground under the digging shanks too much under the shallower conditioned depth, especially where the tractor tires roll, making the ground progressively change too hard, slick and dangerous. This can be dangerous for the horses and riders and can give an unfair advantage to different contestants depending on their position in a competition order. In order to try to mitigate this, the event is often paused to redo the preparation sequence.

An arena grooming machine that better maintains the ground conditions during equine and other events would be an improvement in the art. Such a machine or system that was relatively simple to use and provided additional flexibility to address different ground issues would be a further improvement in the art.

### SUMMARY

The present disclosure includes improved arena grooming machines, as well as systems, methods and apparatus for arena grooming. In some illustrative embodiments, an improved grooming machine includes a number of digging shanks formed as a set on a framework that that can be adjusted to different depths, similar to known machines, and an additional set of maintaining shanks. The maintaining shanks are designed thin to slit the deeper ground with reduced “digging” compared to the digging shanks and may be mounted on an independent bar, which is deployable to a fixed consistent position above the ground, and not moving up or down with the digging shanks. The number and position of maintaining shanks can be changed depending on the event, ground conditions and tractor used, allowing the maintaining shanks to be positioned in alignment with the wheels of the tractor to address compression occurring from repeated arena grooming.

In some illustrative embodiments, an improved grooming machine may include a leveling bar assembly that allows the leveling bar to be adjusted to present different depths and different pitches and to be removed for replacement with another groundworking tool.

Processes and methods of using improved grooming machines in accordance with the present disclosure are also included in the present disclosure.

### DESCRIPTION OF THE DRAWINGS

It will be appreciated by those of ordinary skill in the art that the various drawings are for illustrative purposes only. The nature of the present disclosure, as well as other embodiments of the present invention, may be more clearly understood by reference to the following detailed description, to the appended claims, and to the several drawings.

FIG. 1 is a front perspective view of a first illustrative embodiment of an arena grooming machine assembly in accordance with the principles of the present disclosure.

FIG. 2A is a front perspective view of another illustrative embodiment of an arena grooming machine in accordance with the principles of the present disclosure.

FIGS. 2B, 20, 2D, 2E, 2F, and 2G are top, bottom, front, back, left side, and right side views of the arena grooming machine of FIG. 2A.

FIGS. 3A and 3B are front and side views of a maintaining shank assembly for an arena grooming system in accordance with the present disclosure.

FIGS. 4A and 4B are side views of the arena grooming machine of FIGS. 2A though 2G with the maintaining shank assembly in a deployed and an undeployed position, respectively.

FIGS. 5A, 5B, 5C and 5D depict a portion of one illustrative embodiment of an adjustable leveling bar assembly for use with an arena grooming machine in accordance with the principles of the present disclosure, with the height and pitch adjustment features thereof, used to place the leveling bar in various adjusted positions.

### DETAILED DESCRIPTION

The present disclosure relates to apparatus, systems and methods for grooming ground, such as arena grounds equestrian events, including arena grooming machines that are towed by a tractor or other prime mover. It will be appreciated by those skilled in the art that the embodiments herein described, while illustrating certain embodiments, are not intended to so limit the disclosure or the scope of the invention. Those skilled in the art will also understand that various combinations or modifications of the embodiments presented herein can be made without departing from the scope of this disclosure. All such alternate embodiments are within the scope of the present invention.

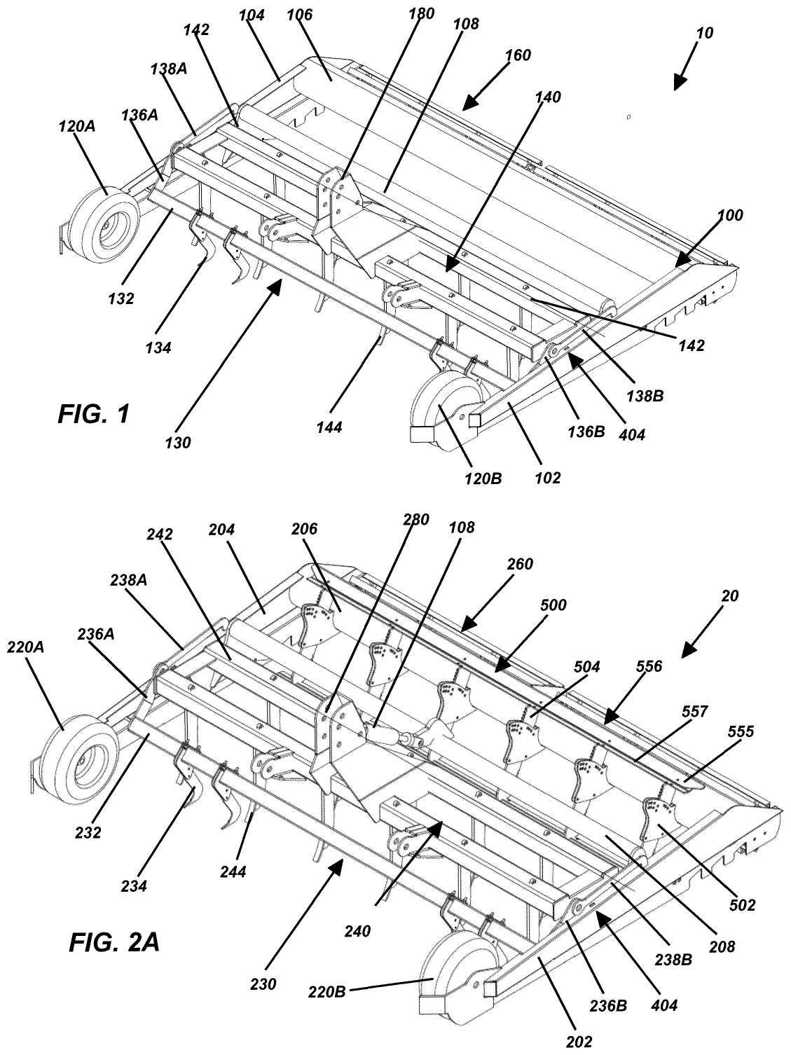

Referring to FIG. 1, a first illustrative embodiment of an arena grooming machine assembly in accordance with the principles of the present disclosure is depicted. The arena grooming machine or system 10 includes a frame or “push box” 100, with left and right sides 102 and 104 joined by a rear strut 106. Medial flanges 107A and 107B may be disposed on the inside of the sides 104 and 102 with medial bar 108 extending therebetween at an upper surface of the system 10.

At a front end, two wheels 120A and 120B may be disposed at the front ends of the two sides 104 and 102 and provide a first point for contact with the ground. As depicted, the wheels 120 and 120B may be attached the sides by axles allowing them to rotate in use.

At the rear end, a cage roller assembly 160 may be disposed rear of the rear strut 106 to provide a final ground surface treatment when in use. As depicted, cage roller assembly, may include two aligned cage rollers, each rotationally attached to a flange extending from the rear strut 106 and to its respective side 102 or 104, but it will be appreciated that embodiments with a single longer cage roller, or a multiple aligned cage rollers are contemplated.

Moving forward, a digging assembly 140 may include a framework 142 supporting a plurality of individual digging shanks 144. In the depicted embodiment, framework 142 include two parallel supports or bars on which a number of digging shanks 144 are disposed. The framework 142 may be adjustable to set different depths for the digging shanks in use. The digging assembly is discussed in more detail further herein but may be similar to that on the Black Widow Arena Ground Working Implement, currently commercially available from the inventor. A connection tower 180 for attachment to a tow bar connected to a tractor or other prime mover may be disposed atop the framework 142 and medial bar 108.

Forward of the digging assembly 142, a maintaining shank assembly 130 may be disposed. A plurality of maintaining shanks 134, which are designed thin to slit the deeper ground with reduced “digging” compared to the digging shanks are movably mounted on an independent bar 132. As depicted, each the width of a maintaining shank 134 may be one half or less than the width of a maintaining shank 144.

The maintaining shank assembly 132, is deployable to a fixed consistent position with the shank 134 in the ground and reversed to an unactuated position with the shanks 134 above the ground using deployment linkages 136A and 136B and deployment bars 138A and 138B on the sides of the box 100. The maintaining shank assembly is discussed in more detail further herein. It will be appreciated that the number and position of maintaining shanks 134 can be changed depending on the event, ground conditions and tractor used, allowing the maintaining shanks 134 to be positioned in alignment with the wheels of the tractor to address compression occurring from repeated arena grooming.

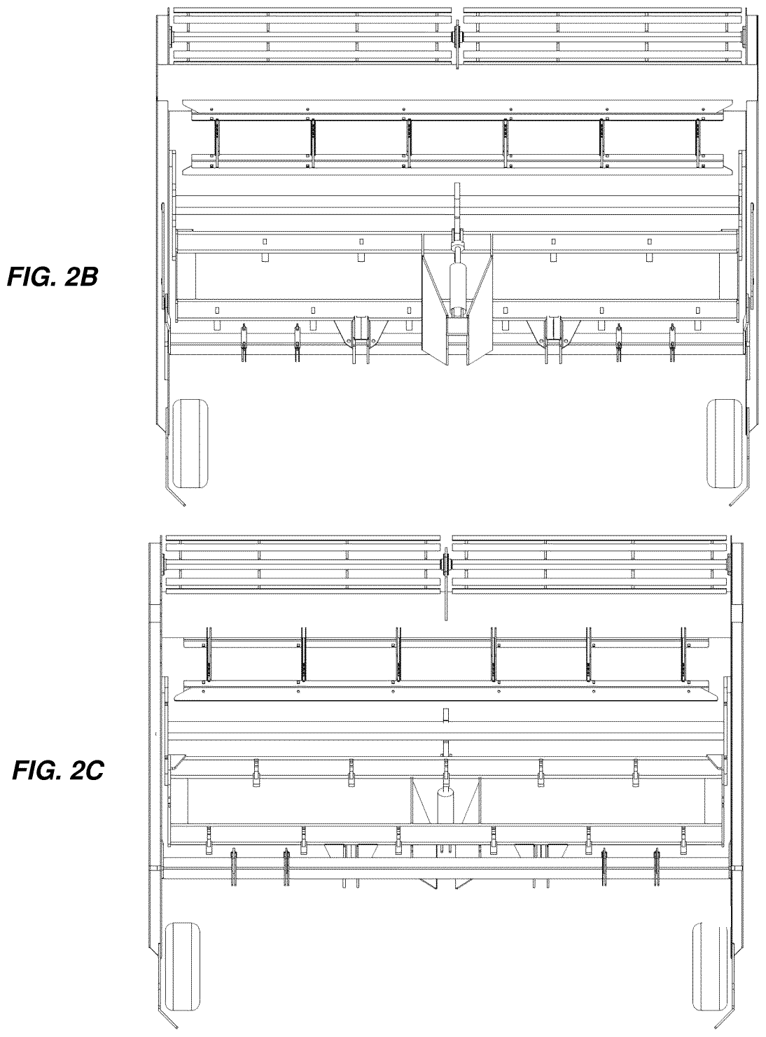

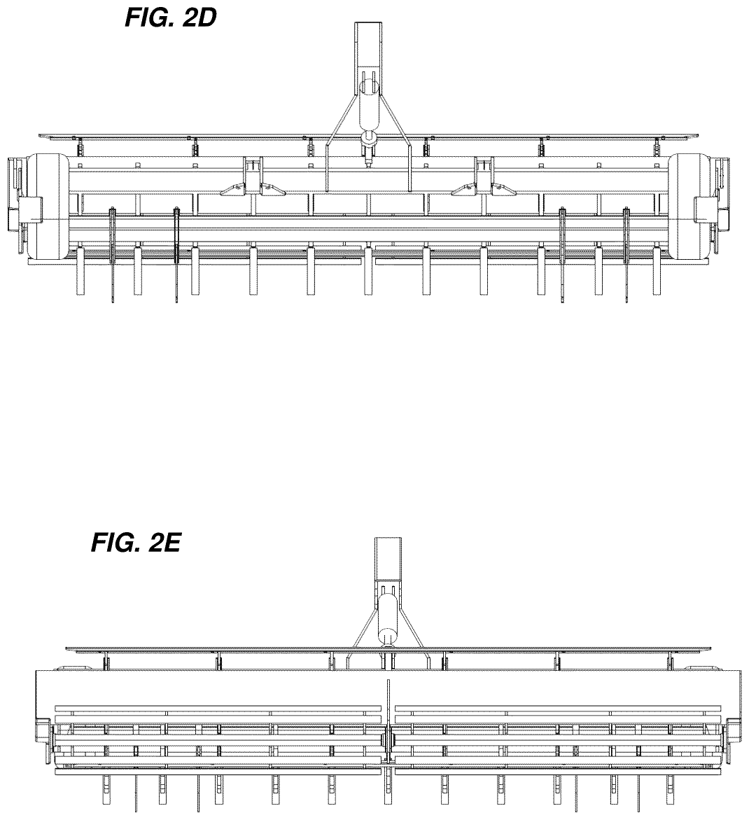

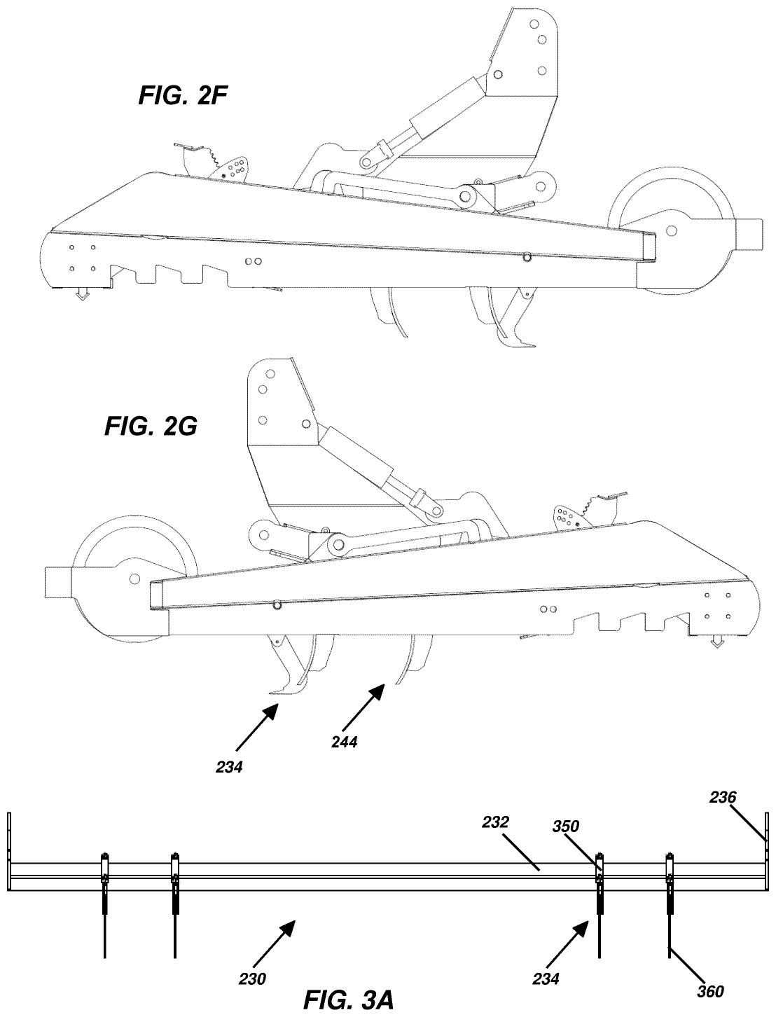

Turning FIGS. 2A through 2G another illustrative embodiment of an arena grooming machine 20 in accordance with the principles of the present disclosure is depicted. Arena grooming machine or system 20 includes a frame or “push box” 200, with left and right sides 202 and 204 joined by a rear strut 206. Medial flanges 207A and 207B may be disposed on the inside of the sides 204 and 202 with medial bar 208 extending therebetween at an upper surface of the system 20.

At a front end, two wheels 220A and 220B may be disposed at the front ends of the two sides 204 and 202 and provide a first point for contact with the ground, when deployed. As depicted, the wheels 220A and 220B may be attached the sides by axles allowing them to rotate in use.

A maintaining shank assembly 230 may be disposed at a front position in the box 100. A plurality of maintaining shanks 234, which are designed thin to slit the deeper ground with reduced “digging” compared to the digging shanks are movably mounted on an independent bar 232. As depicted, each the width of a maintaining shank 234 may be one half or less than the width of a maintaining shank 244.

The maintaining shank assembly 230, is deployable to a fixed consistent position with the shank 234 in the ground and reversed to an unactuated position with the shanks 234 above the ground using deployment linkages 236A and 236B and deployment bars 238A and 238B on the sides of the box 200. As best depicted in FIGS. 2F and 2G, when in use the deployed maintaining shanks 234 extend further downwards into the ground than the deployed digging shanks 244.

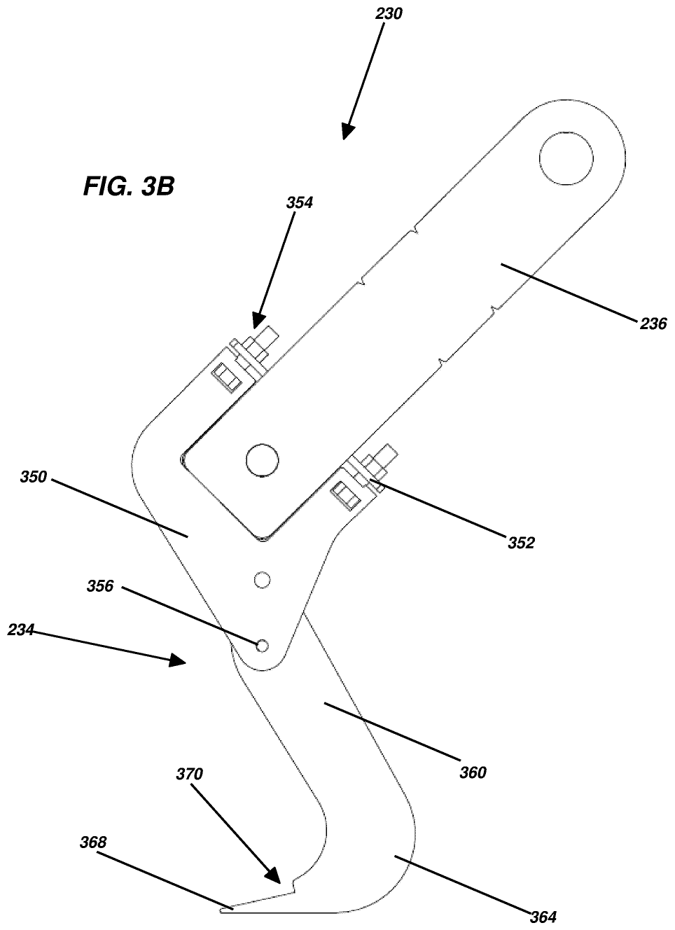

FIGS. 3A and 3B depict a portion of a maintaining shank assembly 230 in more detail in isolation. As depicted, the shank 230 may include a bracket portion 350 and a blade portion 360. Bracket portion 350 may be formed as a bracket body with a recess for attachment to bar 232 using a fastener 354, such as the depicted nuts and bolts passing through a plate 352 to secure the bracket 350 to the bar. The shank assembly 230 may be secured on independent bar at a desired point and can be moved to different positions by loosening and retightening the fasteners. It will be appreciated that the use of a polygonal bar and recess may maintain the position and securement of the assembly.

A pin 356 or bolt may secure blade portion 360 in a lower receiver on the bracket. The blade portion 360 may include an upper body 362, configured for placement in the lower receiver and including a suitable attachment hole for pin 356. It will be appreciated that pin 356 may be a sacrificial shear pin with a predetermined break force, such that it will fracture if the deployed shank strikes a buried rock during use, to limit potential damage to the system.

Body 360 may extend from upper portion though a lower bend 364 to a front cutting portion, including a narrowed tip 368 and a notch 370. Where the body 360 upper portion is formed form a mild steel, the tip may be formed from a hardened steel.

It will be appreciated that the number and position of maintaining shanks 134 or 234 in a system 10 or 20 can be changed depending on the event, ground conditions and tractor used, allowing the maintaining shanks 134/234 to be positioned in alignment with the wheels of the tractor to address compression occurring from repeated arena grooming.

In the depicted embodiment, the maintaining shanks may extend to a depth of from about 10 to about 12 inches when extended. Each shank blade body may have a width of from about 0.5 to about 1.0 inches.

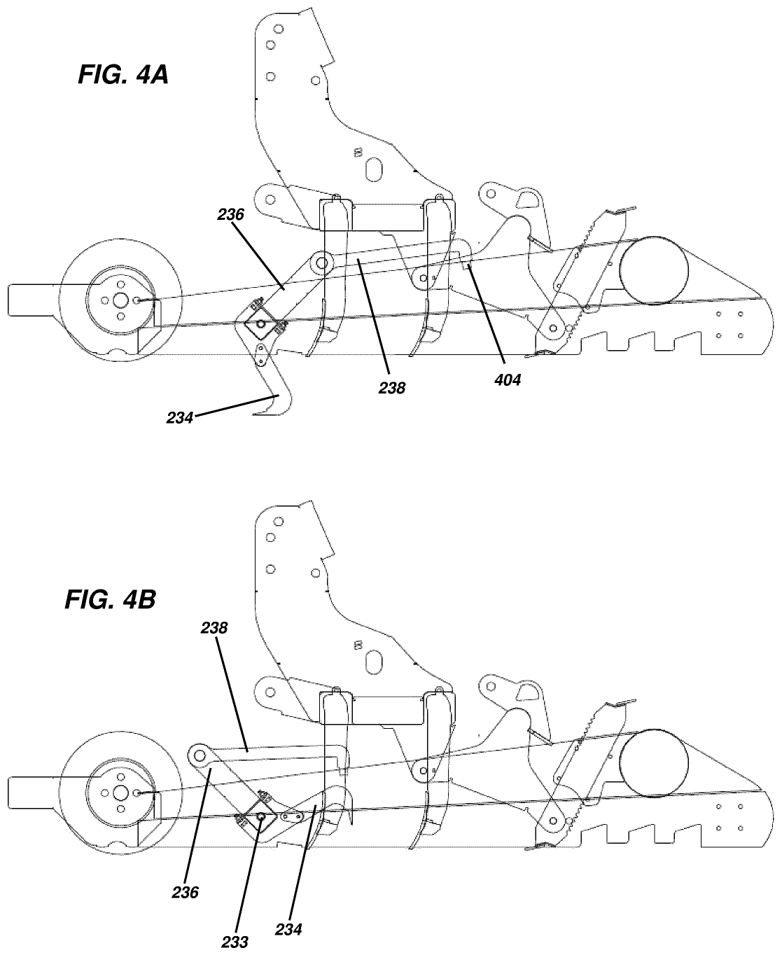

Turning to FIGS. 4A and 4B, the arena grooming machine of FIGS. 2A though 2G with the maintaining shank assembly is depicted in a deployed and an undeployed position, respectively. The deployment bars 238 are moved to a rearward position on the system, pulling the deployment linkages 236 rearward as pivot 235 rotates and causes the independent bar 132 to rotate on axle 233, thereby extending the shanks 234 to the deployed position with the shank 234 extending below the system 20 (FIG. 4A). When the deployment bars 238 are moved to a forward position, the deployment linkages 236 are moved forward as pivot 235 rotates and causes the independent 132 to rotate on axle 233, thereby retracting the shanks 234 from the deployed position to a undeployed position with the shank 234 above the ground. (FIG. 4B). The deployment bars 238 may be secured to retain the assembly in a desired position. In the depicted embodiment, this may be done by inserting the tip of the deployment bar in a deployment socket 402 or a securing socket 404 but it will be appreciated that other securing systems may be used.

Returning to FIGS. 2A though 2G, digging assembly 240 is disposed rearward of the maintaining shank assembly and may include a framework 242 supporting a plurality of individual digging shanks 244. In the depicted embodiment, framework 242 may include two parallel supports or bars on which a number of digging shanks 244 are disposed. The framework 242 may be adjustable to set different depths for the digging shanks in use. A connection tower 280 for attachment to a tow bar connected to a tractor or other prime mover may be disposed atop the framework 142 and be connected to the medial bar 208 by a hydraulic piston 210 allowing the rip depth of the digging shanks to be adjusted by the tractor hydraulics. In use, the digging shanks may be relatively wide in comparison to the maintaining shanks, with a width of from about two to about six inches. The digging shanks may be removably attached by shear pins or bolts and may have replaceable digging tips. In use, the digging shanks may be placed at a depth of about 6 to about 8 inches into the ground for preparation prior to an event and from, about, 1 to about 3 inches for maintenance during an event.

The medial bar and tower may also be used to rotate and/or lift the system, 20 to a stowed position with the wheels disposed downwards and the rear end disposed upwards for transport.

As depicted in FIGS. 2A though 2G, an improved grooming machine in accordance with the present disclosure may include a leveling bar assembly 500 that allows a leveling bar 506 to be adjusted to present different depths and different pitches and to be removed to for replacement with another groundworking tool. As depicted the assembly 500 may include a plurality of support members 502 attached to the rear strut 106. Each support member 502 may be formed from two parallel plates that extend out from the rear strut in a forward direction, spaced to hold a leveling bar support arm 504 therebetween.

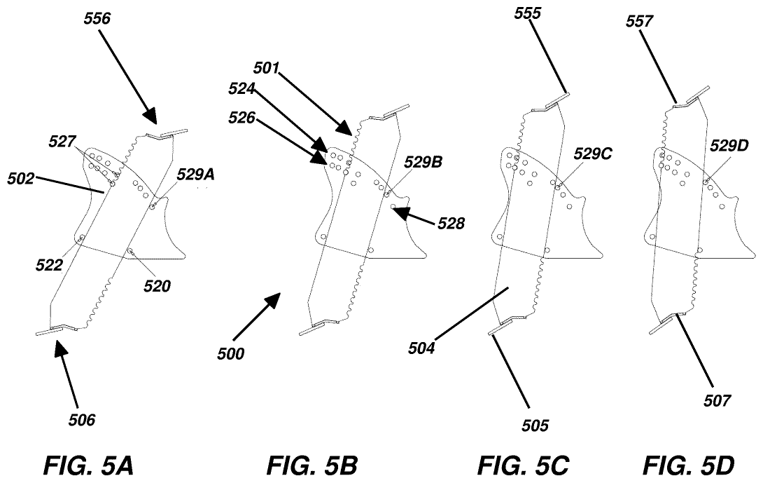

Turning to FIGS. 5A-5D, a single leveling bar support arm 504 and support member 502 is depicted in various installed positions. As depicted, the bar 504 may be a planar member designed for reversible use, having a front surface with a lower portion having a smooth surface and an upper portion with a series of height adjustment recesses, depicted as semicircular recesses 501, and a rear surface having an upper portion with a smooth surface and a lower portion with a series of corresponding recesses, such that when the arm 504 is withdrawn from the support member 502 and reinserted in an inverted position, the former front surface becomes the rear surface and vice versa.

A leveling bar 506 may be disposed at a lower position on the leveling bar assembly 500 and may include a cutting member 505 and a reinforcing support member 507. As depicted in FIGS. 2A-2G these may be extended members that span across multiple leveling bar support arms 504 to have a width similar to the other groundworking tools on system 20. The reinforcing support member 507 may be formed to correspond to a seat on the end of the leveling bars, and the cutting member may be formed as a planar member with a leading edge. In the depicted embodiment, a second leveling bar 556 may be disposed at an upper position on the leveling bar assembly 500 and may include a cutting member 555 and a support member 557. The second cutting bar assembly 556 may serve as a reserve member that can be deployed by reversing the assembly as the leveling bars are worn. Additionally, it will be appreciated that the upper position may be used to store a different groundworking assembly that could be deployed on the leveling bars installed when leveling bar 506 is moved to the upper stowed position.

As may be most clearly seen in FIG. 5A, the support member includes a set of lower “block” holes neared the lower end, with lower front block hole 522 and lower rear block hole 520, these holes pass through both parallel plates of the support member allowing pins or bolts to be inserted therethrough to retain the support arm 504 therebetween.

Near the upper end, the support member may include a set of height adjustment holes, shown as the parallel rows of holes 524 and 526 (FIG. 5B), which are disposed in a front portion of the support member as to allow pins or bolts inserted therethrough to pass through both parallel plates of the support member and reside in selected members of the height adjustment recesses 501 to retain the support arm 504 at a desired height, such as in selected members 527. Similarly, the support member may include a set of “trap” adjustment holes, shown as the row of holes 528, which are disposed in a rear portion of the support member as to allow pins or bolts inserted therethrough to pass through both parallel plates of the support member and retain the arm therebetween the fasteners inserted therethrough and the fasteners inserted through the height adjustment holes 524 and 526.

As depicted, the height adjustment holes 524 and 526 and trap holes 528 may be formed in curved rows to provide for the pitch of the arm 504 and leveling bar 506 to be maintained at a desired selected pitch. FIGS. 5A, 5B, 5C and 5D 5 depict different selected pitches obtained by using different trap adjustment holes 529A, 529B, 529C and 529C of the row 528. Different soil conditions are different arenas may make it desirable to select different angles or heights for the leveling bar to cut into the soil for preparing or maintaining the ground for events.

Returning to FIGS. 2A through 2G, at the rear end of the assembly 200, a cage roller assembly 260 may be disposed rear of the rear strut 206 to provide a final ground surface treatment when in use. As depicted, cage roller assembly 260, may include two aligned cage rollers, each rotationally attached to a flange extending from the rear strut 206 and to its respective side 202 or 204, but it will be appreciated that embodiments with a single longer cage roller, or a multiple aligned cage rollers are contemplated.

While this disclosure has been described using certain embodiments, the present disclosure can be further modified while keeping within its spirit and scope. This application is therefore intended to cover any variations, uses, or adaptations of the disclosure using its general principles. Further, this application is intended to cover such departures from the present disclosure as come within known or customary practices in the art to which this invention pertains and which fall within the limits of the appended claims.

1. An arena grooming machine, comprising:
a framework with a rear member and side members that define an open area;
a connection assembly attached to the framework, the connection assembly configured for connecting the arena grooming machine to a tow vehicle;
a digging assembly connected to the framework and disposed in the open area, the digging assembly comprising a first frame supporting a plurality of digging shanks, each digging shank having a digging portion configured for deployment in the ground during use, the digging portion having a first width;
a maintaining assembly connected to the framework and disposed in the open area, the maintaining assembly comprising a second frame supporting a plurality of maintaining shanks, each maintaining shank having a cutting portion configured for deployment in the ground during use, the cutting portion having a second width, wherein the first width is greater than the second width.

2. The arena grooming machine of claim 1, wherein the first width is at least double the second width.

3. The arena grooming machine of claim 1, wherein the length of the cutting portion of the maintaining shanks is longer than the digging portion of the digging shanks.

4. The arena grooming machine of claim 1, wherein the maintaining assembly second frame comprises a bar on which the plurality of maintaining shanks are disposed, and the assembly further comprises a linkage that moves the bar from an undeployed position to the deployed position with the maintaining shanks extended to penetrate the ground.

5. The arena grooming machine of claim 4, wherein each maintaining shank is laterally adjustable on the bar.

6. The arena grooming machine of claim 1, wherein the maintaining assembly is positioned near a front of the framework and the digging assembly is positioned rearward of the maintaining assembly.

7. The arena grooming machine of claim 1, further comprising a leveling bar assembly, comprising a ground leveling cutting bar extending across the open portion of the framework, the leveling bar positioned rearward of the digging assembly.

8. The arena grooming machine of claim 7, wherein leveling bar assembly include pitch adjustment features allowing the pitch of the ground leveling cutting bar to be altered.

9. The arena grooming machine of claim 1, further comprising a roller cage assembly, comprising a roller cage disposed at a rear of the framework, the roller cage pivotally attached to the framework and positioned to rotate and condition the ground surface.

10. The arena grooming machine of claim 1, wherein the connection assembly comprises a tow tower for connection to a tractor tow bar.

11. An arena grooming machine, comprising:
a framework with a rear member and side members that define an open area;
a connection assembly attached to the framework, the connection assembly configured for connecting the arena grooming machine to a tow vehicle;
a digging assembly connected to the framework and comprising a plurality of digging shanks, each digging shank having a digging portion configured for deployment in the ground during use, the digging portion having a first width;
a maintaining assembly connected to the framework and disposed in the open area, the maintaining assembly comprising a second frame, including a bar and a first linkage assembly, wherein a plurality of maintaining shanks are disposed on the bar, and the first linkage assembly moves the bar from an undeployed position to the deployed position with the plurality of maintaining shanks extended to penetrate the ground, and
wherein each maintaining shank having a cutting portion configured for deployment in the ground during use, the cutting portion having a second width, wherein the first width is greater than the second width.

12. The arena grooming machine of claim 11, wherein the first width is at least double the second width.

13. The arena grooming machine of claim 1, wherein the length of the cutting portion of the maintaining shanks is longer than the digging portion of the digging shanks.

14. The arena grooming machine of claim 13, wherein each maintaining shank is laterally adjustable on the bar.

15. The arena grooming machine of claim 11, wherein the maintaining assembly is positioned near a front of the framework and the digging assembly is positioned rearward of the maintaining assembly.

16. The arena grooming machine of claim 11, wherein the digging assembly further comprises a frame including at least a first member connected to the framework and extending laterally across a portion of the open area with at least a portion of the plurality of digging shank disposed on the at least a first member, the at least first member adjustable to alter the depth each digging shank will penetrate the ground during use.

17. The arena grooming machine of claim 11, further comprising a leveling bar assembly, comprising a ground leveling cutting bar extending across the open portion of the framework, the leveling bar positioned rearward of the digging assembly.

18. The arena grooming machine of claim 17, wherein leveling bar assembly include pitch adjustment features allowing the pitch of the ground leveling cutting bar to be altered.

19. The arena grooming machine of claim 18, wherein the leveling bar assembly further comprises at least a first support member comprising two parallel plates forming a channel for placement of an arm connected to the leveling bar, and the pitch adjustment feature comprises corresponding holes in the parallel plates for placement of a pin that secures the arm to maintain the ground leveling cutting bar at a desired pitch.

20. The arena grooming machine of claim 11, further comprising a roller cage assembly, comprising a roller cage disposed at a rear of the framework, the roller cage pivotally attached to the framework and positioned to rotate and condition the ground surface.
